(19) United States
(12) Patent Application Publication
(10) Pub. No.: US 2011/0284151 A1
(43) Pub. Date: Nov. 24, 2011

(54) DOUBLE-SIDED PRESSURE-SENSITIVE ADHESIVE SHEET AND METHOD FOR USING THEREOF

(75) Inventors: Mutsumi KOBAYASHI, Osaka (JP); Naoyuki NISHIYAMA, Osaka (JP)

(73) Assignee: NITTO DENKO CORPORATION, Osaka (JP)

(21) Appl. No.: 13/112,026

(22) Filed: May 20, 2011

(30) Foreign Application Priority Data
May 21, 2010 (JP) 2010-117578

(51) Int. Cl. C09J 7/02; B32B 37/12; B32B 43/00

(52) U.S. Cl. 156/94; 428/354; 428/334; 428/337

(57) ABSTRACT

The present invention provides a double-sided pressure-sensitive adhesive sheet using a plastic film substrate, ensuring good laminating workability and no elongation or rupture at the lamination even when used in a narrow or long form, where the double-sided pressure-sensitive adhesive sheet has excellent adhesive property and at the same time, exerts excellent peelability (releasability) without causing an adhesive residue at the separation. The present invention relates to a double-sided pressure-sensitive adhesive sheet comprising a plastic film substrate; and a pressure-sensitive adhesive layer on both sides of the plastic film substrate, wherein a 180° peeling pressure-sensitive adhesive force of a surface (surface A) of one of the pressure-sensitive adhesive layer to a stainless steel plate as measured at a tensile speed of 300 mm/min is 8 N/20 mm or more, and an adhesive residue is not generated in the releasability evaluation test.

### BACKGROUND OF THE INVENTION

1. Technical Field

The present invention relates to a double-sided pressure-sensitive adhesive sheet. More specifically, the present invention relates to a double-sided pressure-sensitive adhesive sheet having strong adhesive force and excellent releasability. The present invention also relates to a method for using the double-sided pressure-sensitive adhesive sheet.

2. Background Art

A double-sided pressure-sensitive adhesive sheet (including a double-sided pressure-sensitive adhesive tape) is being utilized as joining means assured of good workability and high reliability of adhesion in various industrial fields such as home electric appliances, automobiles and OA equipment. Recently, in view of resource saving, a recyclable component used in finished products is reused in many cases by dismantling the finished product after use. At this time, in the case where the component is adhered to an adherend by using a double-sided pressure-sensitive adhesive sheet, the double-sided pressure-sensitive adhesive sheet laminated needs to be separated (released). The double-sided pressure-sensitive adhesive sheet released in this way is required to, in addition to having adhesion property for fixing a component, ensure that the pressure-sensitive adhesive does not remain on the adherend surface at the separation (adhesive residue preventing property) or the double-sided pressure-sensitive adhesive sheet is not ruptured during separation.

As regards the double-sided pressure-sensitive adhesive sheet used for applications where the adhesive sheet is released, various proposals have been heretofore made. For example, there is known, for preventing a rupture during separation, a double-sided pressure-sensitive adhesive sheet where a pressure-sensitive adhesive layer is provided on both sides of a nonwoven fabric substrate comprising Manila hemp as the main component and at least one of the pressure-sensitive adhesive layers is a water-soluble pressure-sensitive adhesive layer (see, Patent Document 1), or for improving the adhesive residue preventing property, a double-sided adhesive tape where a pressure-sensitive adhesive layer is formed on both sides of a nonwoven fabric substrate and interlaminar fracture is suppressed (see, Patent Document 2).

However, such a double-sided pressure-sensitive adhesive sheet using a nonwoven fabric substrate lacks elasticity and therefore, in use for fixing a narrow or long film or the like, positioning at the lamination is difficult or rupture may occur when releasing the sheet, which significantly deteriorates the workability. In particular, with recent downsizing of the component for home electric appliances or OA equipments, the problem above is actually becoming more serious.

On the other hand, in the case of a double-sided pressure-sensitive adhesive sheet using a plastic film as the substrate (see, Patent Document 3), the problem of weak elasticity or rupture of the substrate may be improved, but because of bad anchoring property of the pressure-sensitive adhesive layer to the substrate, an adhesive residue is generated at the separation from an adherend (a component) and a work to remove the residue is required, still raising a problem of decrease in workability.

Patent Document 1: JP-A-7-70527 (the term “JP-A” as used herein means an “unexamined published Japanese patent application”)

Patent Document 2: JP-A-2003-342544

Patent Document 3: JP-A-2010-37413

### SUMMARY OF THE INVENTION

Accordingly, an object of the present invention is to provide a double-sided pressure-sensitive adhesive sheet using a plastic film substrate, ensuring good laminating workability and no elongation or rupture at the lamination even when used in a narrow or long form, where the double-sided pressure-sensitive adhesive sheet has excellent adhesive property, and exerts excellent peelability (releasability) without causing an adhesive residue at the separation. Another object of the present invention is to provide a double-sided pressure-sensitive adhesive sheet excellent in the property of scarcely allowing for slippage or separation of a member laminated (hereinafter, this property is sometimes referred to as “separation resistance to constant load”), even when peeling stress is applied thereto over a long period of time.

As a result of intensive studies to attain these objects, the present inventors have found that when in a double-sided pressure-sensitive adhesive sheet comprising a plastic film substrate and a pressure-sensitive adhesive layer on both sides of the plastic film substrate, a 180° peeling pressure-sensitive adhesive force of a surface (surface A) of one of the pressure-sensitive adhesive layer of the double-sided pressure-sensitive adhesive sheet to a stainless steel plate is controlled to a specific range, and an adhesive residue is not generated in the later-described releasability evaluation test, a double-sided pressure-sensitive adhesive sheet exhibiting, even when used in a narrow or long shape, good laminating workability and excellent adhesive property and causing no adhesive residue on an adherend at the time of releasing the sheet, can be obtained. The present invention has been accomplished based on this finding.

The present invention provides the following double-sided pressure-sensitive adhesive sheet and method for use of the double-sided pressure-sensitive adhesive sheet.

(1) A double-sided pressure-sensitive adhesive sheet comprising:

a plastic film substrate; and

a pressure-sensitive adhesive layer on both sides of the plastic film substrate,

wherein a 180° peeling pressure-sensitive adhesive force of a surface (surface A) of one of the pressure-sensitive adhesive layer to a stainless steel plate as measured at a tensile speed of 300 mm/min is 8 N/20 mm or more, and an adhesive residue is not generated in the following releasability evaluation test:

releasability evaluation test:

the surface A of the double-sided pressure-sensitive adhesive sheet is laminated to a polystyrene plate such that the laminated part has a size of 20 mm in width and 100 mm in length, the laminate is left standing for 1 month in an atmosphere of 60° C. and 90% RH, the double-sided pressure-sensitive adhesive sheet is then peeled off from the polystyrene plate under the conditions of a peel angle of 180° and a tensile speed of 10 m/min, and the presence or absence of an adhesive residue on the surface of the polystyrene plate is evaluated with an eye.

(2) The double-sided pressure-sensitive adhesive sheet according to (1), wherein a peeling distance measured by the following constant-load peel test is 10 mm or less:

constant-load peel test:

the surface A of the double-sided pressure-sensitive adhesive sheet having a size of 20 mm in width and 60 mm in length is laminated to one surface of a polystyrene plate, the laminate is pressure-contacted by moving a 2-kg rubber roller back and forth once thereover and then cured for 30 minutes, and then a load of 100 gf in a direction perpendicular to the surface of the polystyrene plate is applied to a longitudinal terminal end of the double-sided pressure-sensitive adhesive sheet under the conditions of 23° C. and 50% RH, and the peeling distance of the double-sided pressure-sensitive adhesive sheet after the passage of 3 hours is measured.

(3) The double-sided pressure-sensitive adhesive sheet according to (1) or (2), wherein the plastic film substrate is a plastic film substrate in which out of surfaces of the plastic film substrate, at least the surface on the surface A side is a strong adhesion-treated surface.

(4) A double-sided pressure-sensitive adhesive sheet comprising:

a plastic film substrate; and

a pressure-sensitive adhesive layer on both sides of the plastic film substrate, wherein one of the pressure-sensitive adhesive layer is a pressure-sensitive adhesive layer a having a gel fraction of 5 to 50% and being formed from a pressure-sensitive adhesive composition comprising a tackifying resin and an acrylic polymer comprising, as an essential monomer component, an alkyl(meth)acrylate having a linear or branched alkyl group having a carbon number of 4 to 9, and out of surfaces of the plastic film substrate, at least the surface on the side where the layer a is included is a strong adhesion-treated surface.

(5) The double-sided pressure-sensitive adhesive sheet according to (4), wherein a content of the acrylic polymer is from 50 to 99 wt % based on 100 wt % of a solid content of the pressure-sensitive adhesive composition.

(6) The double-sided pressure-sensitive adhesive sheet according to (4) or (5), wherein the acrylic polymer comprises at least one of n-butyl acrylate and 2-ethylhexyl acrylate as an essential monomer component.

(7) The double-sided pressure-sensitive adhesive sheet according to any one of (4) to (6), wherein the acrylic polymer comprises, as a monomer component, n-butyl acrylate in an amount of 50 wt % or more based on 100 wt % of the total amount of a monomer component constituting the acrylic polymer.

(8) The double-sided pressure-sensitive adhesive sheet according to any one of (4) to (7), wherein the pressure-sensitive adhesive composition comprises a tackifying resin in an amount of from 10 to 50 parts by weight and an isocyanate-based crosslinking agent in an amount of 1.0 part by weight or more and less than 3.0 parts by weight based on 100 parts by weight of the acrylic polymer, and a thickness of the layer a is from 2 to 100 μm.

(9) The double-sided pressure-sensitive adhesive sheet according to any one of (1) to (4), wherein a thickness of the plastic film substrate is from 20 to 200 μm.

(10) The double-sided pressure-sensitive adhesive sheet according to any one of (1) to (9), wherein a breaking strength in the machine direction is 50 N/10 mm or more and a yield point strength in the machine direction is 20 N/10 mm or more.

(11) A method for using the double-sided pressure-sensitive adhesive sheet according to any one of (1) to (10), comprising laminating the surface A (surface of the layer a) of the double-sided pressure-sensitive adhesive sheet to a recyclable member in home electric appliances or an OA equipment.

The double-sided pressure-sensitive adhesive sheet of the present invention is highly elastic thanks to having a plastic film substrate and in turn, exhibits good laminating workability even when used for fixing a narrow or long member (component). Also, the 180° peeling pressure-sensitive adhesive force of the double-sided pressure-sensitive adhesive to a stainless steel plate is controlled to a specific range, and an adhesive residue is not generated in the later-described releasability evaluation test, so that the pressure-sensitive adhesive sheet can keep high adhesive property while it is laminated to an adherend and, by contrast, the pressure-sensitive adhesive sheet can exert excellent releasability at the separation from the adherend. Furthermore, in the double-sided pressure-sensitive adhesive sheet of the present invention, the peeling distance measured by a constant-load peel test is controlled to a specific range and therefore, even when the adhered/fixed member, component or the like is subjected to a peeling stress over a long period of time, the property of scarcely causing slippage or separation of such a member or the like is fully brought out to offer excellent adhesion reliability.

### BRIEF DESCRIPTION OF THE DRAWINGS

FIG. 1 is an illustrative view (perspective view) showing the positional relationship among a test plate, a double-sided pressure-sensitive adhesive sheet and a weight in a constant-load peel test.

FIG. 2 is an illustrative view (side view) showing the positional relationship among a test plate, a double-sided pressure-sensitive adhesive sheet and a weight at the start of measurement in a constant-load peel test.

FIG. 3 is an illustrative view (side view) showing the peeled state and peeling distance of a pressure-sensitive adhesive sheet after the passage of 3 hours from the start of measurement in a constant-load peel test.

FIG. 4 is an illustrative view (side view) showing the positional relationship between a double-sided pressure-sensitive adhesive sheet and a measurement table at the evaluation of workability in Examples and the deflection distance.

### DESCRIPTION OF REFERENCE NUMERALS AND SIGNS

11 Polystyrene plate
12 Double-sided pressure-sensitive adhesive sheet (or measurement sample (double-sided pressure-sensitive adhesive sheet/PET film))
13 Weight
14 Terminal end position at which the double-sided pressure-sensitive adhesive sheet (or measurement sample) and the polystyrene plate are closely contacted at the start of measurement
15 Terminal end position at which the double-sided pressure-sensitive adhesive sheet (or measurement sample) and the polystyrene plate are closely contacted after the passage of 3 hours
16 Peeling distance
21 Double-sided pressure-sensitive adhesive sheet
22 Measurement table
23 Terminal end part
24 Deflection distance

### DETAILED DESCRIPTION OF THE INVENTION

The double-sided pressure-sensitive adhesive sheet of the present invention comprises a plastic film substrate and a pressure-sensitive adhesive layer on both sides of the plastic film substrate. In the description of the present invention, a surface of one of the pressure-sensitive adhesive layer (pressure-sensitive adhesive surface) of the double-sided pressure-sensitive adhesive sheet of the present invention is referred to as a surface A, and a surface of another of the pressure-sensitive adhesive layer (pressure-sensitive adhesive surface) is referred to as a surface B. Incidentally, the “double-sided pressure-sensitive adhesive sheet” as used in the description of the present invention includes a tape form, that is, a “double-sided pressure-sensitive adhesive tape”. Also, in the description of the present invention, the machine direction (MD) indicates the production line direction (flow direction) in the production process of the pressure-sensitive adhesive sheet, and in the case of a long sheet, it indicates the longitudinal direction, and the transverse direction (TD) indicates a direction (orthogonal direction) perpendicular to the machine direction.

The double-sided pressure-sensitive adhesive sheet of the present invention is highly elastic thanks to having a plastic film substrate, can be laminated to an adherend without causing elongation or rupture even when used in a narrow or long form, and thus excels at the laminating workability. In addition, troubles such as rupture are not generated when separating the sheet from an adherend, and the pressure-sensitive adhesive sheet is excellent also in the peeling workability. Particularly, by virtue of having a plastic film substrate, the tensile strength or yield point strength of the double-sided pressure-sensitive adhesive sheet can be easily controlled to the following specific range and in such a case, the workability is more enhanced. In contrast, conventional double-sided pressure-sensitive adhesive sheets having glassine paper or nonwoven fabric as the substrate are lacking elasticity and in turn, poor in the laminating workability or peeling workability.

The plastic film substrate is not particularly limited and, for example, plastic films exemplified later in the specific configuration of the double-sided pressure-sensitive adhesive sheet may be used. In particular, the later-described plastic film substrate in which at least one surface is a strong adhesion-treated surface can be preferably used. In the double-sided pressure-sensitive adhesive sheet of the present invention, out of the surfaces of the plastic film substrate, at least the surface on the surface A side of the double-sided pressure-sensitive adhesive sheet is a strong adhesion-treated surface, whereby the releasability on the surface A side is enhanced.

The 180° peeling pressure-sensitive adhesive force of the surface A of the double-sided pressure-sensitive adhesive sheet of the present invention to a stainless steel plate (SUS plate) as measured at a tensile speed of 300 mm/min (hereinafter, sometimes referred to as a “180° peeling pressure-sensitive adhesive force (surface A)”) is 8 N/20 mm or more (for example, from 8 to 30 N/20 mm), preferably from 14 to 25 N/20 mm. When the 180° peeling pressure-sensitive adhesive force (surface A) is 8 N/20 mm or more, a member or the like can be firmly laminated and fixed to an adherend, and when the 180° peeling pressure-sensitive adhesive force (surface A) is 30 N/20 mm or less, the pressure-sensitive adhesive sheet is easily released. In this respect, the 180° peeling pressure-sensitive adhesive force (surface A) can be measured by performing a 180° peel test (tensile speed: 300 mm/min) of the double-sided pressure-sensitive adhesive sheet to a stainless steel plate (a polishing plate of SUS304) with use of a tensile tester. Specifically, the 180° peeling pressure-sensitive adhesive force can be measured by the method described later in the paragraph of “(1) 180° Peeling Pressure-Sensitive Adhesive Force ” of (Evaluation).

A 180° peeling pressure-sensitive adhesive force of the surface B of the double-sided pressure-sensitive adhesive sheet of the present invention to a stainless steel plate as measured at a tensile speed of 300 mm/min (hereinafter, sometimes referred to as a “180° peeling pressure-sensitive adhesive force (surface B)”) is not particularly limited but, for example, is preferably 8 N/20 mm or more (for example, from 8 to 30 N/20 mm), more preferably from 14 to 25 N/20 mm. When the 180° peeling pressure-sensitive adhesive force (surface B) is 8 N/20 mm or more, a member or the like can be firmly laminated and fixed to an adherend, and when the 180° peeling pressure-sensitive adhesive force (surface B) is 30 N/20 mm or less, the pressure-sensitive adhesive sheet is easily released. In this respect, the 180° peeling pressure-sensitive adhesive force (surface B) can be measured by the same method as that of the 180° peeling pressure-sensitive adhesive force (surface A).

The double-sided pressure-sensitive adhesive sheet of the present invention is required to cause no adhesive residue on a polystyrene plate in the later-described releasability evaluation test with respect to the surface A side. If an adhesive residue remains on the polystyrene plate in the releasability evaluation test, an adhesive residue is readily generated on a plastic-made adherend (a member or the like) such as polystyrene (PS) or a mixed resin of polycarbonate (PC) and acrylonitrile-butadiene-styrene resin (ABS resin), which are widely used, for example, in home electric appliances and OA equipments, and workability or the like when recycling such an adherend (a member or the like) is impaired.

The releasability evaluation test is a test where the surface A of the double-sided pressure-sensitive adhesive sheet is laminated (pressure-contacted) to a polystyrene plate (POLYSTYRENE PLATE™, manufactured by RP TOPLA Limited) by moving a 2-kg roller back and forth once thereover such that the laminated part has a size of 20 mm in width and 100 mm in length, the laminate is left standing for 1 month in an atmosphere of 60° C. and 90% RH, the double-sided pressure-sensitive adhesive sheet is then peeled off from the polystyrene plate under the conditions of a peel angle of 180° and a tensile speed of 10 m/min, and the presence or absence of an adhesive residue on the polystyrene plate surface is evaluated with an eye. Specifically, this evaluation can be performed by the method described later in the paragraph of “(2) Releasability Evaluation Test” of (Evaluation). Incidentally, the term “adhesive residue” as used herein means a phenomenon that after a pressure-sensitive adhesive sheet is separated from an adherend, a part of the pressure-sensitive adhesive layer remains on the adherend surface.

With regard to the presence or absence of an adhesive residue on a polystyrene plate in a releasability evaluation test with respect to the surface B side of the double-sided pressure-sensitive adhesive sheet of the present invention, it is not particularly limited. In the case of causing no adhesive residue in the releasability evaluation test with respect to the surface B side, the releasability on the surface B side is also excellent and therefore, the pressure-sensitive adhesive sheet can be suitably used for applications where the surface B side is laminated to a recyclable member or the like. However, the double-sided pressure-sensitive adhesive sheet of this type is not limited to the applications above and, for example, is also preferably used for applications in which the surface B side is laminated to a member or the like requiring no release of the pressure-sensitive adhesive sheet (applications where a member or the like is semi-permanently fixed). Incidentally, the releasability evaluation test with respect to the surface B side can be performed by the same method as in the releasability evaluation test with respect to the surface A side.

The peeling distance of the double-sided pressure-sensitive adhesive sheet of the present invention as measured by the following constant-load peel test with respect to the surface A side is preferably 10 mm or less, more preferably from 0 to 7 mm, still more preferably from 0 to 3 mm. This peeling distance becomes an index indicating insusceptibility to occurrence of slippage or separation of a member or the like when a peeling stress such as static load is imposed on the member or the like laminated through the double-sided pressure-sensitive adhesive sheet over a long period of time. By setting the peeling distance to 10 mm or less, even when a peeling stress is imposed on a laminated/fixed member or the like over a long period of time, slippage or separation of such a member or the like scarcely occurs and excellent adhesion reliability is offered.

The constant-load peel test is performed as follows.

The surface A of the double-sided pressure-sensitive adhesive sheet (20 mm (width)×60 mm (length)) is laminated to one surface of a polystyrene plate (POLYSTYRENE PLATE™, manufactured by RP TOPLA Limited), and the laminate is pressure-contacted by moving a 2-kg rubber roller back and forth once thereover, and then cured for 30 minutes. Thereafter, a load of 100 gf in the direction perpendicular to the polystyrene plate surface is applied to the longitudinal terminal end of the double-sided pressure-sensitive adhesive sheet under the conditions of 23° C. and 50% RH, and the length of the double-sided pressure-sensitive adhesive sheet separated (peeling distance) after the passage of 3 hours is measured.

More specifically, the constant-load peel test is performed as follows.

### [Constant-Load Peel Test]

The surface A of the double-sided pressure-sensitive adhesive sheet (20 mm (width)×60 mm (length)) is laminated to one surface of a polystyrene plate (POLYSTYRENE PLATE™, manufactured by RP TOPLA Limited, 100 mm (length)×30 mm (width)), and the laminate is pressure-contacted by moving a 2-kg rubber roller back and forth once thereover, and then cured for 30 minutes.

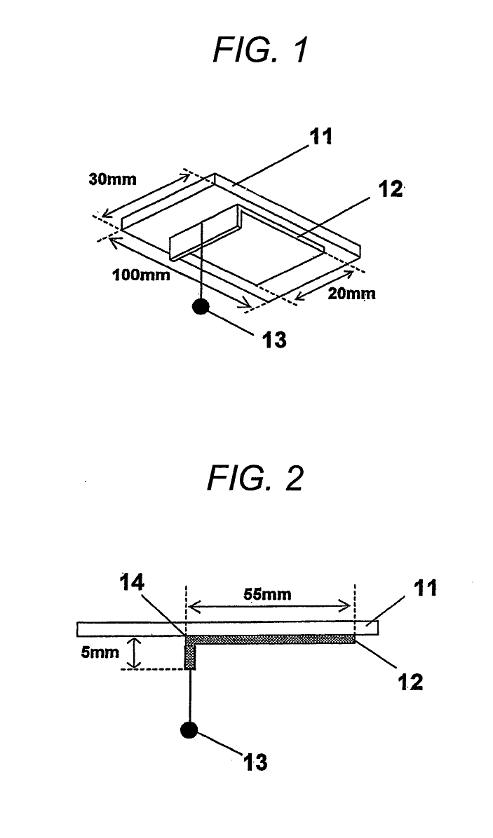

Subsequently, as shown in FIGS. 1 and 2, the polystyrene plate 11 is horizontally placed such that the surface laminated with the double-sided pressure-sensitive adhesive sheet 12 is the bottom surface. The double-sided pressure-sensitive adhesive sheet 12 is peeled 5 mm longitudinally from the longitudinal terminal end (one terminal end), a weight 13 of 100 g is hung with thread from the longitudinal edge (at a widthwise center position), and a load of 100 gf in the direction perpendicular to the polystyrene plate surface is applied to the longitudinal terminal end of the double-sided pressure-sensitive adhesive sheet 12.

Thereafter, the system is left standing for 3 hours under the conditions of 23° C. and 50% RH, and the peeling distance 16 of the double-sided pressure-sensitive adhesive sheet 12 is measured.

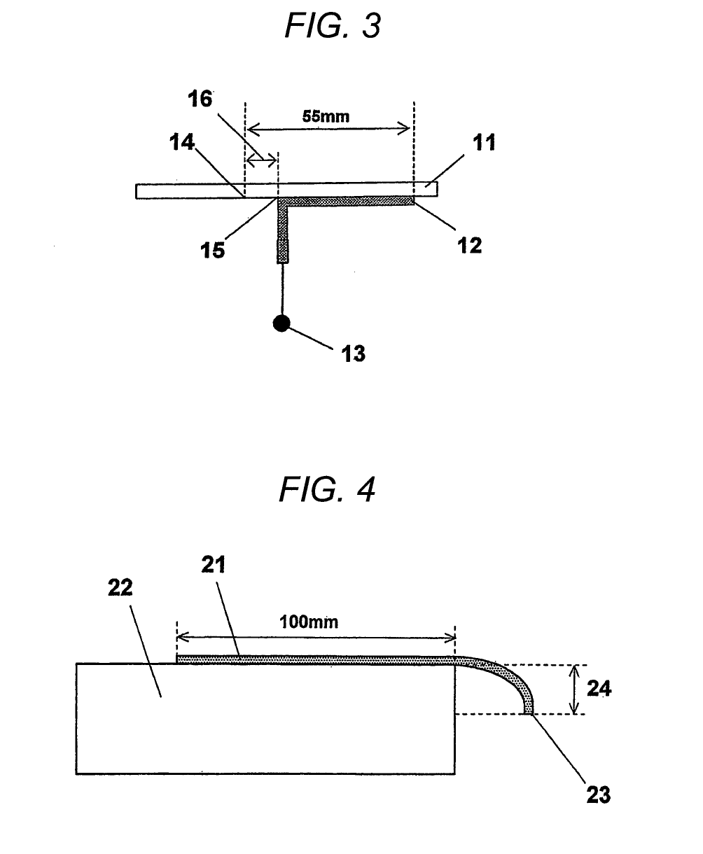

In this connection, the peeling distance is the length (longitudinal distance) of the pressure-sensitive adhesive sheet separated with the passage of 3 hours after the start of measurement and indicates a distance 16 between the end position 14 where the double-sided pressure-sensitive adhesive sheet and the polystyrene plate are closely contacted at the start of measurement, and the end position 15 where the double-sided pressure-sensitive adhesive sheet and the polystyrene plate are closely contacted after the passage of 3 hours (see, FIGS. 2 and 3).

Incidentally, the double-sided pressure-sensitive adhesive sheet may be used for measurement after a polyethylene terephthalate (PET) film (thickness: 25 μm) is laminated (lined) to the pressure-sensitive adhesive surface opposite the polystyrene plate side.

The peeling distance of the double-sided pressure-sensitive adhesive sheet of the present invention in the constant-load peel test with respect to the surface B side is not particularly limited but, for example, is preferably 10 mm or less, more preferably from 0 to 7 mm, still more preferably from 0 to 3 mm. By setting the peeling distance to 10 mm or less, even when a peeling stress is imposed on the laminated/fixed member or the like over a long period of time, slippage or separation of such a member or the like is less caused and excellent adhesion reliability is offered. The peeling distance in the constant-load peel test with respect to the surface B side can be measured by the same method as in the above-described constant-load peel test with respect to the surface A side.

The tensile strength (breaking strength) in the machine direction of the double-sided pressure-sensitive adhesive sheet of the present invention is not particularly limited but, for example, is preferably 50 N/10 mm or more (for example, from 50 to 300 N/10 mm), more preferably from 100 to 250 N/10 mm. By setting the tensile strength in the machine direction to 50 N/10 mm or more, elongation or rupture (particularly, rupture) is scarcely caused at the lamination, and the laminating workability is enhanced. In particular, when the double-sided pressure-sensitive adhesive sheet is used in a narrow or long form, positioning or laminating to the lamination site may be sometimes performed while applying a tensile stress and in such a case, excellent laminating workability is exhibited, because elongation or rupture of the double-sided pressure-sensitive adhesive sheet scarcely occurs. Furthermore, rupture is less caused also when separating the double-sided pressure-sensitive adhesive sheet, and the peeling workability is enhanced.

The yield point strength in the machine direction of the double-sided pressure-sensitive adhesive sheet of the present invention is not particularly limited but, for example, is preferably 20 N/10 mm or more (for example, from 20 to 200 N/10 mm), more preferably from 50 to 150 N/10 mm. By setting the yield point strength in the machine direction to 20 N/10 mm or more, in particular, even when used in a narrow or long form, elongation or rupture (especially, rupture) scarcely occurs at the lamination, and the laminating workability is enhanced.

The tensile strength and yield point strength of the double-sided pressure-sensitive adhesive sheet of the present invention can be measured by a tensile test using a tensile tester in accordance with JIS K7127 (1999). Here, the tensile strength (breaking strength) indicates the tensile load when the double-sided pressure-sensitive adhesive sheet is ruptured, and the yield point strength indicates the tensile load when the double-sided pressure-sensitive adhesive sheet reaches the yielding point. More specifically, these can be measured by the method described later in the paragraph of “(5) Tensile Strength (Breaking Strength) and Yield Point Strength” of (Evaluation).

The double-sided pressure-sensitive adhesive sheet of the present invention comprises a plastic film substrate, where the 180° peeling pressure-sensitive adhesive force of the surface A to a stainless steel plate is controlled to the range above, and an adhesive residue is not generated in the above-described releasability evaluation test with respect to the surface A side. Accordingly, the double-sided pressure-sensitive adhesive sheet of the present invention exhibits good laminating workability even when used in a narrow or long form, and at least the surface A side exerts excellent adhesive property and releasability. Furthermore, when the peeling distance of the double-sided pressure-sensitive adhesive sheet of the present invention as measured by a constant-load peel test with respect to the surface A is controlled to the range above, excellent separation resistance to a constant load is exerted. Incidentally, the surface B side of the double-sided pressure-sensitive adhesive sheet of the present invention is not particularly limited but may be a pressure-sensitive adhesive surface, similarly to the surface A side, having excellent adhesive property and releasability, and further exerting excellent separation resistance to a constant load.

The double-sided pressure-sensitive adhesive sheet of the present invention has the above-described characteristics and therefore, can be suitably used as a double-sided pressure-sensitive adhesive sheet capable of keeping excellent adhesive property (strong adhesive property) while a member or the like is adhered and fixed, and exerting excellent peelability (releasability) at the separation from the member or the like (strong-adhesion releasable double-sided pressure-sensitive adhesive sheet). Specific examples of the application requiring such a strong adhesion releasable double-sided pressure-sensitive adhesive sheet include an application for joining a recyclable (reusable) member (for example, a member composed of polystyrene, a mixed resin of polycarbonate and ABS, or the like) with another member (for example, a consumable member discarded after use, such as film, buffer and label) in products such as OA equipments and home electric appliances. Above all, such a pressure-sensitive adhesive sheet is preferably used when the member is a long or narrow member. Incidentally, the double-sided pressure-sensitive adhesive sheet of the present invention is not limited to the application above and may be used also for semi-permanently fixing a member or an adherend.

The method for using the double-sided pressure-sensitive adhesive sheet of the present invention is not particularly limited but, for example, in the case of joining a recyclable member with the above-described consumable member, includes a method for joining an article where the recyclable member is laminated to the surface A of the double-sided pressure-sensitive adhesive sheet of the present invention and the consumable member is laminated to the surface B, thereby laminating and fixing these two members. In the thus joined members, the double-sided pressure-sensitive adhesive sheet and the consumable member can be separated and removed from the recyclable member without causing an adhesive residue and therefore, workability in the separation step, and productivity of an article (product) or the like produced through the separation step are enhanced.

The double-sided pressure-sensitive adhesive sheet of the present invention comprises a plastic film substrate and a pressure-sensitive adhesive layer on both sides of the plastic film substrate, and as long as the 180° peeling pressure-sensitive adhesive force of the surface A to a stainless steel plate is controlled to the above-described specific range and an adhesive residue is not generated in the above-described releasability evaluation test with respect to the surface A side, its configuration is not particularly limited, but specific examples thereof include a double-sided pressure-sensitive adhesive sheet comprising a plastic film substrate and a pressure-sensitive adhesive layer on both sides of the plastic film substrate, where at least one of the pressure-sensitive adhesive layer is an acrylic pressure-sensitive adhesive layer.

One of specific configurations of the double-sided pressure-sensitive adhesive sheet of the present invention is a double-sided pressure-sensitive adhesive sheet comprising a plastic film substrate and a pressure-sensitive adhesive layer on both sides of the plastic film substrate, wherein one of the pressure-sensitive adhesive layer is a pressure-sensitive adhesive layer (layer a) having a gel fraction of 10 to 50% and being formed from a pressure-sensitive adhesive composition comprising a tackifying resin and an acrylic polymer comprising, as an essential monomer component, an alkyl (meth)acrylate having a linear or branched alkyl group having a carbon number of 4 to 9, and out of the surfaces of the plastic film substrate, at least the surface on the side where the layer a is included is a strong adhesion-treated surface.

The double-sided pressure-sensitive adhesive sheet of the above-described specific configuration is described in detail below.

The double-sided pressure-sensitive adhesive sheet of the above-described specific configuration comprises a layer a on one surface side of the plastic film substrate and a layer b on another surface side of the plastic film substrate. The surface of the layer a in the double-sided pressure-sensitive adhesive sheet of the specific configuration corresponds to the surface A and is a surface (pressure-sensitive adhesive surface) exerting at least strong adhesive property and releasability.

The plastic film substrate in the double-sided pressure-sensitive adhesive sheet of the specific configuration is a substrate supporting the pressure-sensitive adhesive layers (layer a and layer b) and has a role of enhancing laminating workability and peeling workability of the double-sided pressure-sensitive adhesive sheet when used in a narrow or long form. The substrate also has a role of enhancing the processability of the double-sided pressure-sensitive adhesive sheet.

The plastic film substrate is not particularly limited, but there may be used, for example, a plastic film composed of a plastic film material such as polyester-based resin (e.g., polyethylene terephthalate (PET)), acrylic resin (e.g., polymethyl methacrylate (PMMA)), polycarbonate, triacetyl cellulose (TAC), polysulfone, polyallylate, polyimide, polyvinyl chloride, polyvinyl acetate, polyethylene, polypropylene, ethylene-propylene copolymer, and cyclic olefin-based polymer (e.g., ARTON™ (manufactured by JSR, a cyclic olefin-based polymer), ZEONOR™ (manufactured by ZEON Corporation, a cyclic olefin-based polymer)). In this respect, one of these plastic film materials may be used alone, or two or more thereof may be used in combination. Also, the plastic film substrate may have either form of a single layer or a multilayer. Above all, in view of availability or cost, the plastic film substrate is preferably a plastic film composed of a polyester-based resin, more preferably a polyethylene terephthalate (PET) film.

In the double-sided pressure-sensitive adhesive sheet of the above-described specific configuration, out of the surfaces of the plastic film substrate, at least the surface on the side where the layer a is included is a strong adhesion-treated surface. The strong adhesion-treated surface is not particularly limited, but examples thereof include a surface subjected to an oxidation treatment by a chemical or physical method, such as chromic acid treatment, ozone exposure, flame exposure, high-voltage electric shock exposure, corona treatment (corona discharge treatment) and ionization radiation treatment, and a surface subjected to a coating treatment or the like with a primer. Among these, in view of mass productivity, the strong adhesion-treated surface is preferably a surface subjected to a corona treatment (corona-treated surface).

Incidentally, the “strong adhesion treatment” is sometimes referred to as an “easy adhesion treatment”.

That is, the plastic film substrate is preferably a plastic film substrate prepared by subjecting at least one surface of the above-described plastic film (particularly, PET film) to a corona treatment (a plastic film substrate with at least one surface being a corona-treated surface). Such a plastic film substrate is not particularly limited but may be obtained, for example, by applying the above-described oxidation treatment (particularly, a corona treatment) or coating treatment to at least one surface of the plastic film (particularly, PET film), or a commercial product such as LUMIRROR S105™ (manufactured by Toray Industries, Inc.) may be also used.

The wetting tension of the strong adhesion-treated surface (particularly, a corona-treated surface) of the plastic film substrate is preferably 45 mN/m or more, more preferably 50 mN/m or more. By setting the wetting tension of the strong adhesion-treated surface to 45 mN/m or more, the anchoring property of the pressure-sensitive adhesive layer provided on the strong adhesion-treated surface is enhanced and an anchoring failure is less caused at the separation from an adherend, as a result, the releasability is enhanced. In the case of a double-sided pressure-sensitive adhesive tape comprising a PET film as a substrate, the anchoring failure is generally liable to occur when the tape is peeled off at a high speed (for example, a tensile speed of 10 m/min) from an adherend to which the tape is laminated. On the other hand, in the double-sided pressure-sensitive adhesive tape of the above-described specific configuration, the wetting tension of the strong adhesion-treated surface (particularly, a corona-treated surface) is set to 45 mN/m or more, whereby when the surface side of the pressure-sensitive adhesive layer provided on the strong adhesion-treated surface is laminated and then the tape is peeled off at a high speed, excellent releasability is exhibited without causing an adhesive residue. Incidentally, the wetting tension can be measured in accordance with JIS K6768 (1999).

The Young's modulus in the machine direction of the plastic film substrate is not particularly limited but, for example, is preferably 2 GPa or more, more preferably 3 GPa or more. By setting the Young's modulus in the machine direction to 2 GPa or more, even when the double-sided pressure-sensitive adhesive sheet is used in a narrow or long form, elongation is not caused at the lamination, and the laminating workability is enhanced. Incidentally, the Young's modulus in the machine direction can be measured using a tensile tester in accordance with JIS K7161 (1994).

The thickness of the plastic film substrate is not particularly limited but, for example, is preferably from 20 to 200 μm, more preferably from 50 to 125 μm, still more preferably from 75 to 100 μm. By setting the thickness to 20 μm or more, elongation or rupture of the double-sided pressure-sensitive adhesive sheet is less caused. In particular, by setting the thickness to 75 μm or more, the double-sided pressure-sensitive adhesive sheet becomes elastic to facilitate positioning at the lamination together even when the double-sided pressure-sensitive adhesive sheet is used in a narrow or long form, and furthermore, elongation or rupture less occurs at laminating (pressure-contacting) to an adherend, whereby the laminating workability is enhanced. Also, by setting the thickness to 200 μm or less, the processability of the double-sided pressure-sensitive adhesive sheet is improved and this is advantageous in view of cost.

The layer a in the double-sided pressure-sensitive adhesive sheet of the above-described specific configuration is an acrylic pressure-sensitive adhesive layer formed from a pressure-sensitive adhesive composition (an acrylic pressure-sensitive adhesive composition) comprising an acrylic polymer and a tackifying resin as essential components.

The acrylic polymer constituting the layer a is a polymer comprising, as an essential monomer component, an alkyl(meth)acrylate having a linear or branched alkyl group with a carbon number of 4 to 9 (hereinafter, sometimes referred to as a “C₄₋₉ alkyl(meth)acrylate”). The monomer component constituting the acrylic polymer may further comprise, as a copolymerization monomer component, a polar group-containing monomer, a polyfunctional monomer and other copolymerizable monomers. The content of the acrylic polymer in the pressure-sensitive adhesive composition is preferably from 50 to 99 wt %, more preferably from 60 to 80 wt %, based on the solid content (100 wt %) of the pressure-sensitive adhesive composition. Here, the term “(meth)acryl” indicates “acryl” and/or “methacryl”, and the same applies to others.

Examples of the C₄₋₉ alkyl(meth)acrylate include n-butyl(meth)acrylate, isobutyl(meth)acrylate, s-butyl(meth)acrylate, tert-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate and isononyl(meth)acrylate. One of these C₄₋₉ alkyl(meth)acrylates may be used alone, or two or more thereof may be used in combination. Above all, n-butyl acrylate (BA) and 2-ethylhexyl acrylate (2EHA) are preferred. That is, the acrylic polymer is preferably an acrylic polymer comprising n-butyl acrylate or 2-ethylhexyl acrylate as an essential monomer component.

In view of releasability, the content of the C₄₋₉ alkyl(meth)acrylate is preferably 50 wt % or more (for example, from 50 to 99 wt %), more preferably from 80 to 99 wt %, still more preferably from 90 to 99 wt %, based on the total amount (100 wt %) of monomer components constituting the acrylic polymer. By setting the content to 50 wt % or more, characteristics (e.g., pressure-sensitive adhesive property, releasability) as an acrylic polymer are readily brought out. Particularly, in the present invention, the content of n-butyl acrylate is preferably 50 wt % or more (for example, from 50 to 99 wt %), more preferably from 80 to 99 wt %, still more preferably from 90 to 99 wt %, based on the total amount (100 wt %) of monomer components constituting the acrylic polymer. That is, the acrylic polymer preferably comprises, as a monomer component, n-butyl acrylate in an amount of 50 wt % or more based on the total amount (100 wt %) of monomer component constituting the acrylic polymer.

Examples of the polar group-containing monomer include a carboxyl group-containing monomer such as (meth)acrylic acid, itaconic acid, maleic acid, fumaric acid, crotonic acid and isocrotonic acid (including an acid anhydride group-containing monomer such as maleic anhydride and itaconic anhydride); a hydroxyl group-containing monomer such as 2-hydroxyethyl(meth)acrylate, 3-hydroxypropyl(meth)acrylate, 4-hydroxybutyl(meth)acrylate, 6-hydroxyhexyl(meth)acrylate, vinyl alcohol and allyl alcohol; an amide group-containing monomer such as (meth)acrylamide, N,N-dimethyl(meth)acrylamide, N-methylol(meth)acrylamide, N-methoxymethyl(meth)acrylamide, N-butoxymethyl(meth)acrylamide and N-hydroxyethyl(meth)acrylamide; an amino group-containing monomer such as aminoethyl(meth)acrylate, dimethylaminoethyl(meth)acrylate and tert-butylaminoethyl(meth)acrylate; an epoxy group-containing monomer such as glycidyl(meth)acrylate and methylglycidyl(meth)acrylate; a cyano group-containing monomer such as acrylonitrile and methacrylonitrile; a heterocyclic ring-containing vinyl-based monomer such as N-vinyl-2-pyrrolidone, (meth)acryloylmorpholine, N-vinylpiperidone, N-vinylpiperazine, N-vinylpyrrole and N-vinylimidazole; a sulfonic acid group-containing monomer such as sodium vinylsulfonate; a phosphoric acid group-containing monomer such as 2-hydroxyethylacryloylphosphate; an imide group-containing monomer such as cyclohexylmaleimide and isopropylmaleimide; an isocyanate group-containing monomer such as 2-methacryloyloxyethyl isocyanate; and an alkoxyalkyl(meth)acrylate such as 2-methoxyethyl(meth)acrylate, 2-ethoxyethyl(meth)acrylate, methoxytriethylene glycol(meth)acrylate, 3-methoxypropyl(meth)acrylate, 3-ethoxypropyl(meth)acrylate, 4-methoxybutyl(meth)acrylate and 4-ethoxybutyl(meth)acrylate. One of these polar group-containing monomers may be used alone, or two or more thereof may be used in combination. Above all, a carboxyl group-containing monomer and a hydroxyl group-containing monomer are preferred, and acrylic acid (AA), 2-hydroxyethyl acrylate and 4-hydroxybutyl acrylate are more preferred.

The content of the polar group-containing monomer is preferably from 1 to 20 parts by weight, more preferably from 5 to 15 parts by weight, based on the content (100 parts by weight) of the C₄₋₉ alkyl(meth)acrylate. By setting the content of the polar group-containing monomer to 1 part by weight or more, the pressure-sensitive adhesive property is readily exhibited, and by setting the content to 20 parts by weight or less, it becomes easy to take a balance of the pressure-sensitive adhesive characteristics.

Out of the polar group-containing monomers, in view of a balance among the increase in adhesive force, the hardness and the polarity, the content of the carboxyl group-containing monomer (particularly, acrylic acid) is preferably from 1 to 15 parts by weight, more preferably from 1 to 10 parts by weight, still more preferably from 1 to 5 parts by weight, based on the content (100 parts by weight) of the C₄₋₉ alkyl acrylate. By setting the content of the carboxyl group-containing monomer to 1 part by weight or more, the adhesive property is increased, and by setting the content to 15 parts by weight or less, it becomes easy to take a balance of the characteristics.

Out of the polar group-containing monomers, from the standpoint of accelerating the crosslinking, the content of the hydroxyl group-containing monomer is preferably from 0.01 to 1 part by weight, more preferably from 0.01 to 0.8 parts by weight, still more preferably from 0.01 to 0.5 parts by weight, based on the content (100 parts by weight) of the C₄₋₉ alkyl(meth)acrylate. By setting the content of the hydroxyl group-containing monomer to 0.01 parts by weight or more, crosslinking of the pressure-sensitive adhesive layer can be accelerated to shorten the curing time. Also, by setting the content to 1 part by weight or less, gelling at an excessively high rate is prevented and the coatability is enhanced.

Examples of the polyfunctional monomer include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl(meth)acrylate, vinyl(meth)acrylate, divinylbenzene, epoxy acrylate, polyester acrylate and urethane acrylate. One of these polyfunctional monomers may be used alone, or two or more thereof may be used in combination.

Examples of the copolymerizable monomer (other copolymerizable monomers) other than the polar group-containing monomer and the polyfunctional monomer include (meth)acrylates other than the above-described C₄₋₉ alkyl(meth)acrylate, polar group-containing monomer and polyfunctional monomer, the (meth)acrylates including an alkyl(meth)acrylate with the alkyl group having a carbon number of 1 to 3, such as methyl(meth)acrylate, ethyl(meth)acrylate, propyl(meth)acrylate and isopropyl(meth)acrylate, an alkyl(meth)acrylate having a linear or branched alkyl group having a carbon number of 10 to 20, such as decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate and eicosyl(meth)acrylate, (meth)acrylate having an alicyclic hydrocarbon group, such as cyclopentyl(meth)acrylate, cyclohexyl(meth)acrylate and isobornyl(meth)acrylate, and a (meth)acrylate having an aromatic hydrocarbon group, such as phenyl(meth)acrylate, phenoxyethyl(meth)acrylate and benzyl(meth)acrylate; vinyl esters such as vinyl acetate and vinyl propionate; aromatic vinyl compounds such as styrene and vinyltoluene; olefins or dienes such as ethylene, butadiene, isoprene and isobutylene; vinyl ethers such as vinyl alkyl ether; and vinyl chloride.

The acrylic polymer can be prepared by polymerizing the monomer component above by a conventionally known polymerization method. Examples of the polymerization method for the acrylic polymer include a solution polymerization method, an emulsion polymerization method, a bulk polymerization method, and a polymerization method by active energy ray irradiation (active energy ray polymerization method). Among these, a solution polymerization method is preferred in view of cost and mass productivity. At the polymerization, proper components according to the polymerization method, such as polymerization initiator, chain transfer agent, emulsifier and solvent, may be appropriately selected from known or conventional compounds and used.

Examples of the polymerization initiator used at the polymerization of the acrylic polymer include an azo-based polymerization initiator, a peroxide-based polymerization initiator (e.g., dibenzoyl peroxide, tert-butyl permaleate), and a redox-type polymerization initiator. Above all, azo-based polymerization initiators disclosed in JP-A-2002-69411 are preferred. Such an azo-based polymerization initiator is advantageous because its decomposition product scarcely remains as a moiety giving rise to generation of a heat-generating gas (outgas), in the acrylic polymer. Examples of the azo-based polymerization initiator include 2,2′-azobisisobutyronitrile (hereinafter, sometimes referred to as “AIBN”), 2,2′-azobis-2-methylbutyronitrile (hereinafter, sometimes referred to as “AMBN”), dimethyl 2,2′-azobis(2-methylpropionate) and 4,4′-azobis-4-cyanovaleric acid. The amount of the azo-based polymerization initiator used is preferably from 0.01 to 1 part by weight based on the total amount (100 parts by weight) of monomer components constituting the acrylic polymer.

At the solution polymerization, various general solvents can be used. Examples of the solvent include organic solvents such as esters (e.g., ethyl acetate and n-butyl acetate), aromatic hydrocarbons (e.g., toluene and benzene), aliphatic hydrocarbons (e.g., n-hexane and n-heptane), alicyclic hydrocarbons (e.g., cyclohexane, and methylcyclohexane), and ketones (e.g., methyl ethyl ketone and methyl isobutyl ketone). One of these solvents may be used alone, or two or more thereof may be used in combination.

From the standpoint of enhancing the pressure-sensitive adhesive property, the pressure-sensitive adhesive composition for forming the layer a comprises a tackifying resin (tackifier) as an essential component. Examples of the tackifying resin include a terpene-based tackifying resin, a phenolic tackifying resin, a rosin-based tackifying resin and a petroleum-based tackifying resin. One of these tackifying resins may be used alone, or two or more thereof may be used in combination. Above all, a rosin-based tackifying resin is preferred.

Examples of the terpene-based tackifying resin include a terpene-based resin such as α-pinene polymer, β-pinene polymer and dipentene polymer, and a modified terpene-based resin (e.g., terpene phenolic resin, styrene-modified terpene-based resin, aromatic modified terpene-based resin, or hydrogenated terpene-based resin) obtained by modifying (for example, phenol modification, aromatic modification, hydrogenation modification or hydrocarbon modification) the terpene-based resin above.

Examples of the phenolic tackifying resin include a condensate (e.g., alkylphenolic resin, or xylene formaldehyde-based resin) of various phenols (e.g., phenol, m-cresol, 3,5-xylenol, p-alkylphenol, or resorcin) with formaldehyde, a resol obtained by addition-reacting the phenols above with formaldehyde in the presence of an alkali catalyst, a novolak obtained by condensation-reacting the phenols above with formaldehyde in the presence of an acid catalyst, and a rosin-modified phenol resin obtained by adding and thermally polymerizing phenol and rosins (for example, an unmodified rosin, a modified rosin or various rosin derivatives) in the presence of an acid catalyst.

Examples of the rosin-based tackifying resin include an unmodified rosin (natural rosin) such as gum rosin, wood rosin and tall oil rosin, a modified rosin (e.g., hydrogenated rosin, disproportionated rosin, polymerized rosin, or other chemically modified rosins) obtained by modifying the unmodified rosin above through hydrogenation, disproportionation, polymerization or the like, and various rosin derivatives. Examples of the rosin derivative include rosin esters, for example, a rosin ester compound obtained by esterifying an unmodified rosin with alcohols, and a modified rosin ester compound obtained by esterifying a modified rosin (e.g., hydrogenated rosin, disproportionated rosin, or polymerized rosin) with alcohols; unsaturated fatty acid-modified rosins obtained by modifying an unmodified rosin or a modified rosin (e.g., hydrogenated rosin, disproportionated rosin, or polymerized rosin) with an unsaturated fatty acid; unsaturated fatty acid-modified rosin esters obtained by modifying rosin esters with an unsaturated fatty acid; rosin alcohols obtained by reducing the carboxyl group in unmodified rosins, modified rosins (e.g., hydrogenated rosin, disproportionated rosin, or polymerized rosin), unsaturated fatty acid-modified rosins or unsaturated fatty acid-modified rosin esters; and metal salts of rosins (particularly, rosin esters) such as unmodified rosin, modified rosin and various rosin derivatives.

Examples of the petroleum-based tackifying resin which can be used include a known petroleum resin such as aromatic petroleum resin, aliphatic petroleum resin, alicyclic petroleum resin (aliphatic cyclic petroleum resin), aliphatic.aromatic petroleum resin, aliphatic.alicyclic petroleum resin, hydrogenated petroleum resin, coumarone-based resin and coumarone-indene-based resin. More specifically, examples of the aromatic petroleum resin include a polymer using only one species or two or more species of vinyl group-containing aromatic hydrocarbons having a carbon number of 8 to 10 (e.g., styrene, o-vinyltoluene, m-vinyltoluene, p-vinyltoluene, α-methylstyrene, β-methylstyrene, indene, and methylindene). As the aromatic petroleum resin, an aromatic petroleum resin (so-called “C9 petroleum resin”) obtained from a fraction (so-called “C9 petroleum fraction”) such as vinyl toluene and indene may be suitably used. Examples of the aliphatic petroleum resin include a polymer using only one species or two or more species of olefins or dienes having a carbon number of 4 to 5 (for example, an olefin such as butene-1, isobutylene and pentene-1; and a diene such as butadiene, piperylene (1,3-pentadiene) and isoprene). As the aliphatic petroleum resin, an aliphatic petroleum resin (so-called “C4 petroleum resin” or “C5 petroleum resin”) obtained from a fraction (so-called “C4 petroleum fraction” or “C5 petroleum fraction”) such as butadiene, piperylene and isoprene may be suitably used. Examples of the alicyclic petroleum resin include an alicyclic hydrocarbon-based resin obtained by cyclizing and dimerizing an aliphatic petroleum resin (so-called “C4 petroleum resin” or “C5 petroleum resin”) and then polymerizing the dimer, a polymer of cyclic diene compound (e.g., cyclopentadiene, dicyclopentadiene, ethylidene norbornene, dipentene, ethylidene bicycloheptene, vinylcycloheptene, tetrahydroindene, vinylcyclohexene, or limonene), a hydrogenation product thereof, and an alicyclic hydrocarbon-based resin obtained by hydrogenating the aromatic ring in the above-described aromatic hydrocarbon resin or the aliphatic-aromatic petroleum resin described below. Examples of the aliphatic-aromatic petroleum resin include a styrene-olefin-based copolymer. As the aliphatic-aromatic petroleum resin, a so-called “C5/C9 copolymer petroleum resin” or the like may be used.

The tackifying resin may be a commercial product and, for example, SUMILITERESIN PR-12603™, manufactured by Sumitomo Bakelite Co., Ltd. and PENSEL D125™, manufactured by Arakawa Chemical Industries, Ltd. may be used.

The content of the tackifying resin in the pressure-sensitive adhesive composition for forming the layer a is not particularly limited but, for example, is preferably from 10 to 50 parts by weight, more preferably from 35 to 50 parts by weight, based on the acrylic polymer (100 parts by weight). By setting the content to 10 parts by weight or more, the adhesive property (pressure-sensitive adhesive property) is enhanced. In particular, by setting the content to 35 parts by weight or more, the peeling distance in the constant-load peel test can be easily controlled to the range above and the member is scarcely slipped or separated even when subjected to a peeling stress over a long period of time, which yields excellent adhesion reliability. Also, by setting the content to 50 parts by weight or less, an adhesive residue in the releasability evaluation test is prevented (suppressed) and the releasability is enhanced.

Furthermore, the pressure-sensitive adhesive composition preferably comprises a crosslinking agent. By using a crosslinking agent, the base polymer (the above-described acrylic polymer) constituting the pressure-sensitive adhesive layer (layer a) can be crosslinked, and the cohesive force of the pressure-sensitive adhesive layer can be more increased. The crosslinking agent is not particularly limited, and a crosslinking agent appropriately selected from known or conventional compounds may be used. Specific examples of the crosslinking agent which is preferably used include a polyfunctional melamine compound (melamine-based crosslinking agent), a polyfunctional epoxy compound (epoxy-based crosslinking agent) and a polyfunctional isocyanate compound (isocyanate-based crosslinking agent). One of these crosslinking agents may be used alone, or two or more thereof may be mixed and used. Above all, an isocyanate-based crosslinking agent is preferred.

Examples of the isocyanate-based crosslinking agent (polyfunctional isocyanate compound) include lower aliphatic polyisocyanates such as 1,2-ethylene diisocyanate, 1,4-butylene diisocyanate and 1,6-hexamethylene diisocyanate; alicyclic polyisocyanates such as cyclopentylene diisocyanate, cyclohexylene diisocyanate, isophorone diisocyanate, hydrogenated tolylene diisocyanate and hydrogenated xylene diisocyanate; and aromatic polyisocyanates such as 2,4-tolylene diisocyanate, 2,6-tolylene diisocyanate, 4,4′-diphenylmethane diisocyanate and xylylene diisocyanate. Among these, aromatic polyisocyanates are preferred. As for the commercial product, those available under, for example, CORONATE L™ (manufactured by Nippon Polyurethane Industry Co., Ltd., a trimethylolpropane/tolylene diisocyanate adduct), CORONATE HL™ (manufactured by Nippon Polyurethane Industry Co., Ltd., a trimethylolpropane/hexamethylene diisocyanate adduct), and TAKENATE 110N™ (manufactured by Mitsui Chemicals, Inc.) may be used.

Examples of the epoxy-based crosslinking agent (polyfunctional epoxy compound) include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, diglycidyl adipate, diglycidyl o-phthalate, triglycidyl-tris(2-hydroxyethyl)isocyanurate, resorcin diglycidyl ether, bisphenol-S-diglycidyl ether, and an epoxy-based resin having two or more epoxy groups in the molecule. As for the commercial product, those available under, for example, TETRAD C™ (manufactured by Mitsubishi Gas Chemical Industries Ltd.) may be used.

The content of the crosslinking agent (particularly, isocyanate-based crosslinking agent) in the pressure-sensitive adhesive composition for forming the layer a is not particularly limited but is preferably from 1.0 part by weight or more and less than 3.0 parts by weight, more preferably from 1.5 to 2.5 parts by weight, based on the acrylic polymer (100 parts by weight). By setting the content of the crosslinking agent to 1.0 part by weight or more, a cohesive force is developed and the pressure-sensitive adhesive performance and processability are improved. In particular, by setting the content to 1.5 parts by weight or more, the pressure-sensitive adhesive layer exhibits a sufficiently high cohesive force and the releasability is enhanced. Also, by setting the content of the crosslinking agent to less than 3.0 parts by weight, the peeling distance in the constant-load peel test can be easily controlled to the range above and the member is scarcely slipped or separated even when subjected to a peeling stress over a long period of time, which yields excellent adhesion reliability.

In general, when the content of the isocyanate-based crosslinking agent in the pressure-sensitive adhesive composition is increased, the gel fraction of the pressure-sensitive adhesive layer increases and the separation resistance against a constant load on the surface side of the pressure-sensitive adhesive layer tends to decrease. On the other hand, when the content of the isocyanate-based crosslinking agent is decreased (reduced), the anchoring property of the pressure-sensitive adhesive layer to the plastic film substrate is reduced and this tends to readily cause an anchoring failure when releasing the pressure-sensitive adhesive sheet and reduce the releasability. For this reason, it has been conventionally difficult to achieve both enhancing the anchoring property (enhancement of releasability) and improving the separation resistance against a constant load. On the other hand, in the double-sided pressure-sensitive adhesive sheet of the above-described specific configuration of the present invention, the plastic film surface at least on the side where the layer a is included is designed as a strong adhesion-treated surface and the anchoring property is thereby increased, so that excellent releasability can be exerted without increasing the blending amount of an isocyanate-based crosslinking agent, and at the same time, excellent separation resistance against a constant load can be brought out.

In addition, the pressure-sensitive adhesive composition may further comprise, if desired, known additives such as crosslinking accelerator, anti-aging agent, filler, colorant (for example, a pigment or a dye), ultraviolet absorber, antioxidant, chain transfer agent, plasticizer, softener, surfactant and antistatic agent, and a solvent (for example, a solvent which can be used at the solution polymerization of the acrylic polymer).

The pressure-sensitive adhesive composition can be prepared by mixing an acrylic polymer (or an acrylic polymer solution), a crosslinking agent, a tackifying resin, a solvent and other additives.

The thickness of the layer a in the double-sided pressure-sensitive adhesive sheet of the above-described specific configuration is not particularly limited but is preferably from 2 to 100 μm, more preferably from 10 to 90 μm, still more preferably from 30 to 80 μm. By setting the thickness to 2 μm or more, the adhesive property (pressure-sensitive adhesive property) is developed. In particular, by setting the thickness to 30 μm or more, the peeling distance in the constant-load peel test can be easily controlled to the range above and the member is scarcely slipped or separated even when subjected to a peeling stress over a long period of time, which yields excellent adhesion reliability. Also, by setting the thickness to 100 μm or less, protrusion or the like of the adhesive from the cross-section, which is generated when processing the double-sided pressure-sensitive adhesive sheet, is suppressed.

The gel fraction of the layer a is from 5 to 50% (wt %), preferably from 10 to 50%, more preferably from 10 to 35%, still more preferably from 15 to 25%. By setting the gel fraction to 5% or more, the cohesive force is kept from becoming excessively low and the releasability is enhanced. Also, by setting the gel fraction to 50% or less, the cohesive force is kept from becoming excessively high and the adhesive property (pressure-sensitive adhesive property) is enhanced. In particular, by setting the gel fraction to 35% or less, the peeling distance in the constant-load peel test can be easily controlled to the range above and the member is scarcely slipped or separated even when subjected to a peeling stress over a long period of time, which yields excellent adhesion reliability.

The gel fraction (proportion of the solvent-insoluble part) is specifically a value calculated, for example, by the following “ Gel Fraction Measuring Method”. (Gel Fraction Measuring Method)

About 0.1 g of the pressure-sensitive adhesive layer (layer a) is sampled from the double-sided pressure-sensitive adhesive sheet, wrapped with a porous tetrafluoroethylene sheet (NTF 1122™, manufactured by Nitto Denko Corporation) having an average pore size of 0.2 μm, and it is tied up with a kite string and at this time, it is measured for the weight, and the weight measured is designated as the weight before immersion. Incidentally, the weight before immersion is the total weight of the pressure-sensitive adhesive layer (pressure-sensitive adhesive sampled above), the tetrafluoroethylene sheet and the kite string. The total weight of the tetrafluoroethylene sheet and the kite string is also measured, and this weight is designated as the wrapper weight.

Subsequently, the pressure-sensitive adhesive layer wrapped with a tetrafluoroethylene sheet and tied up with a kite string (hereinafter referred to as the “sample”) is put in a 50 ml-volume vessel filled with ethyl acetate, followed by allowing to stand still at 23° C. for 7 days. The sample (after ethyl acetate treatment) is then taken out of the vessel, and it is transferred to an aluminum-made cup, followed by drying in a dryer at 130° C. for 2 hours to remove ethyl acetate, and it is measured for the weight, and this weight is designated as the weight after immersion.

The gel fraction is calculated according to the following formula:

Gel fraction (wt %)=((X−Y)/(Z−Y))×100

(wherein X is the weight after immersion, Y is the wrapper weight, and Z is the weight before immersion).

The gel fraction can be controlled, for example, by the monomer composition or weight average molecular weight of the acrylic polymer, the amount used (amount added) of the crosslinking agent or the like.

Out of the pressure-sensitive adhesive layers in the double-sided pressure-sensitive adhesive sheet of the above-described specific configuration, the pressure-sensitive adhesive constituting another pressure-sensitive adhesive layer (layer b) is not particularly limited, and, for example, a conventionally known or commonly employed pressure-sensitive adhesive layer formed from a known pressure-sensitive adhesive such as urethane-based pressure-sensitive adhesive, acrylic pressure-sensitive adhesive, rubber-based pressure-sensitive adhesive, silicone-based pressure-sensitive adhesive, polyester-based pressure-sensitive adhesive, polyamide-based pressure-sensitive adhesive, epoxy-based pressure-sensitive adhesive, vinyl alkyl ether-based pressure-sensitive adhesive and fluorine-based pressure-sensitive adhesive may be used. One of these pressure-sensitive adhesives may be used alone, or two or more thereof may be used in combination. In view of adhesive property, the layer b is preferably a pressure-sensitive adhesive layer formed from an acrylic pressure-sensitive adhesive (acrylic pressure-sensitive adhesive layer). Such an acrylic pressure-sensitive adhesive layer is not particularly limited, but examples thereof include the acrylic pressure-sensitive adhesive layers exemplified as the layer a.

The thickness of the layer b is not particularly limited but is preferably from 2 to 100 μm, more preferably from 10 to 90 μm, still more preferably from 30 to 80 μm. By setting the thickness to 2 μm or more, the adhesive property (pressure-sensitive adhesive property) is developed. In particular, by setting the thickness to 30 μm or more, the peeling distance in the constant-load peel test with respect to the layer b side can be easily controlled to the range above and the member is scarcely slipped or separated even when subjected to a peeling stress over a long period of time, which yields excellent adhesion reliability. Also, by setting the thickness to 100 μm or less, protrusion or the like of the adhesive from the cross-section, which is generated when processing the double-sided pressure-sensitive adhesive sheet, is suppressed.

The method for forming the pressure-sensitive adhesive layers (layer a and layer b) in the double-sided pressure-sensitive adhesive sheet of the above-described specific configuration is not particularly limited but includes, for example, a method of applying (coating) the pressure-sensitive adhesive composition on a separator or a plastic film substrate and, if desired, drying and/or curing the coating.

For applying (coating) the composition in the above method for forming the pressure-sensitive adhesive layer, a known coating method can be used, and a commonly employed coater such as gravure roll coater, reverse roll coater, kiss roll coater, dip roll coater, bar coater, knife coater, spray coater, comma coater and direct coater'may be used.

The double-sided pressure-sensitive adhesive sheet of the specific configuration can be produced according to the conventionally known or commonly employed production method of a pressure-sensitive adhesive sheet. For example, the pressure-sensitive adhesive layers (layer a and layer b) may be directly formed on the surfaces of a plastic film substrate (direct method), or the pressure-sensitive adhesive layer is formed on a separator and then it is transferred (laminated together) to a plastic film substrate, thereby providing the pressure-sensitive adhesive layers (layer a and layer b) on the plastic film substrate (transfer method). Of these, from the standpoint of enhancing the anchoring property of the pressure-sensitive adhesive layer to the plastic film substrate, the direct method is preferred.

Each of the pressure-sensitive adhesive layers (layer a and layer b) of the double-sided pressure-sensitive adhesive sheet of the above-described specific configuration may be protected by a separator (release liner) until use. In this connection, the pressure-sensitive adhesive layer surfaces may be individually protected by using two separators or may be protected by one separator with both surfaces being a release surface, in the form of the sheet being wound into a roll. The separator is used as a protective layer for the pressure-sensitive adhesive layer and is separated when the pressure-sensitive adhesive layer is laminated to an adherend. Incidentally, the separator need not be necessarily provided. The separator is not particularly limited, and commonly employed release paper or the like may be used, but, for example, a substrate having a release-treated layer, a low adhesive substrate composed of a fluoropolymer, or a low adhesive substrate composed of a nonpolar polymer can be used. Examples of the substrate having a release-treated layer include a plastic film or paper in which the surface is treated with a release agent such as silicone type, long chain alkyl type, fluorine type and molybdenum sulfide. Examples of the fluorine-based polymer in the low adhesive substrate composed of a fluoropolymer include polytetrafluoroethylene, polychlorotrifluoroethylene, polyvinyl fluoride, polyvinylidene fluoride, tetrafluoroethylene-hexafluoropropylene copolymer and chlorofluoroethylene-vinylidene fluoride copolymer. Examples of the nonpolar polymer include an olefin-based resin such as polyethylene and polypropylene. Particularly, in the case where the laminate of the double-sided pressure-sensitive adhesive sheet and a member is subjected to a half-cut processing (a processing where the separator of the double-sided pressure-sensitive adhesive sheet is not cut) into a narrow or long form (delicate form), the separator is preferably a separator having a polyethylene or polypropylene laminated layer on both sides of a paper substrate such as high-quality paper, or a polyester film separator, because application of such a half-cut processing is facilitated.

In the case where the separator is a separator having a polyethylene or polypropylene laminated layer on both sides of a paper substrate, the thickness of the laminated layer (polyethylene or polypropylene laminated layer) is preferably from 5 to 50 μm, more preferably from 10 to 40 μm. By setting the thickness to 5 μm or more, the half-cut processing is facilitated. Also, by setting the thickness to 50 μm or less, the cost is reduced and the mass productivity is enhanced. The polyethylene composed of the laminated layer is not particularly limited and a conventionally known or commonly employed polyethylene may be used, but examples thereof include a low-density polyethylene, a linear low-density polyethylene, a polyethylene polymerized by metallocene catalyst, a medium-density polyethylene and a high-density polyethylene.

The separator can be formed by a conventionally known or commonly employed method. For example, when the separator is a separator having a polyethylene laminated layer on both sides of a paper substrate, the separator can be formed by extrusion lamination method. A commercial product may be also used, and examples of the commercial product include, for example, SLB-80W5D™ (manufactured by Sumika Kakoshi Co., Ltd.).

The thickness of the separator is not particularly limited but, for example, is preferably from 12 to 200 μm, more preferably from 50 to 150 μm.

The double-sided pressure-sensitive adhesive sheet of the above-described specific configuration comprises a plastic film substrate as the substrate and therefore, is elastic to ensure good laminating workability and peeling workability even when used in a long or narrow form. Also, at least one pressure-sensitive adhesive layer (layer a) is a pressure-sensitive adhesive layer having a specific gel fraction and being formed from a pressure-sensitive adhesive composition having a specific configuration and out of the surfaces of the plastic film substrate, at least the surface on the side where the layer a is included is strong adhesion-treated surface, whereby at least the layer a side can exhibit excellent adhesive property and releasability. Furthermore, when the blending amount of an isocyanate-based crosslinking agent in the pressure-sensitive adhesive composition is controlled to a specific range, excellent separation resistance against a constant load can be also exerted.

In conventional double-sided pressure-sensitive adhesive sheets, a technique of increasing the blending amount of an isocyanate-based crosslinking agent in the pressure-sensitive adhesive composition to enhance the anchoring property of the pressure-sensitive adhesive layer to the substrate and improve the releasability is generally employed. However, when the blending amount of the isocyanate-based crosslinking agent is increased, the gel fraction of the pressure-sensitive adhesive layer is increased and the separation resistance against a constant load is decreased, which makes it difficult to achieve both enhancing the anchoring property (that is, enhancement of releasability) and improving the separation resistance against a constant load. On the other hand, in the double-sided pressure-sensitive adhesive sheet of the above-described specific configuration, the plastic film surface on the side where the layer a is included is designed as a strong adhesion-treated surface and the anchoring property of the layer a is thereby increased, so that excellent releasability can be exerted without increasing the blending amount of an isocyanate-based crosslinking agent and at the same time, excellent separation resistance against a constant load can be brought out.

### EXAMPLES

The present invention is described in greater detail below by referring to Examples, but the present invention is not limited to these Examples. In the following and Table 1, the blending amount of CORONATE L™ is a blending amount (parts by weight) in terms of the solid content.

### Example 1

100 parts by weight of n-butyl acrylate (BA), 2 parts by weight of acrylic acid (AA), 0.1 parts by weight of 2-hydroxyethyl acrylate (HEA) and 5 parts by weight of vinyl acetate as monomer raw materials and toluene as a polymerization solvent was added to a reaction vessel equipped with a stirrer, a thermometer, a reflux condenser, a dropping device and a nitrogen inlet tube. While slowly stirring the mixture, the inside of the vessel was nitrogen-purged by introducing a nitrogen gas, and a reaction solution thereof was obtained. The reaction solution was heated to 60° C., and 0.2 parts by weight of 2,2′-azobisisobutyronitrile (AIBN) as a polymerization initiator was added. The polymerization reaction was performed for 10 hours while keeping the system at 60 to 70° C., to obtain an acrylic acid polymer (copolymer) solution.

In the acrylic polymer solution, 2 parts by weight of an isocyanate-based crosslinking agent (CORONATE L™, manufactured by Nippon Polyurethane Industry Co., Ltd.), 25 parts by weight of a terpene phenolic resin (SUMILITERESIN PR-12603™, manufactured by Sumitomo Bakelite Co., Ltd.) and 15 parts by weight of a polymerized rosin ester resin (PENSEL D125™, manufactured by Arakawa Chemical Industries, Ltd.) were blended based on 100 parts by weight of the acrylic polymer (copolymer) and after adding toluene, these were uniformly mixed to produce a pressure-sensitive adhesive composition solution.

The pressure-sensitive adhesive composition solution was coated on both sides of a PET film with one surface (one of surfaces) being a corona-treated surface (LUMIRROR S-105™, manufactured by Toray Industries, Inc.; thickness: 75 μm, wetting tension of corona-treated surface: 63 mN/m) to have a thickness of 50 μm for each layer after drying, and they were dried at 100° C. for 2 minutes, whereby a double-sided pressure-sensitive adhesive sheet was obtained. In this connection, the pressure-sensitive adhesive layer formed on the corona-treated surface side of the PET film is sometimes referred to as a “pressure-sensitive adhesive layer on the corona-treated surface side” and the pressure-sensitive adhesive layer formed on the surface opposite the corona-treated surface is sometimes referred to as a “pressure-sensitive adhesive layer on the opposite side”. The same applies to the double-sided pressure-sensitive adhesive sheets obtained in Examples 2 and 3. Incidentally, a 135 μm-thick separator (SLB-80W5D™, manufactured by Sumika Kakoshi Co., Ltd.; a separator having a polyethylene laminated layer on both sides of high-quality paper and having a silicon-based release agent layer on the laminated layer surface) was provided on the pressure-sensitive adhesive surface on both sides of the double-sided pressure-sensitive adhesive sheet.

### Example 2

A double-sided pressure-sensitive adhesive sheet was obtained in the same manner as in Example 1 except that, as shown in Table 1, a PET film with one surface being a corona-treated surface (LUMIRROR S10S™ manufactured by Toray Industries, Inc.; thickness: 38 μm, wetting tension of corona-treated surface: 63 mN/m) was used as the substrate and the thickness of each pressure-sensitive adhesive layer was changed to 40 μm.

### Example 3

A double-sided pressure-sensitive adhesive sheet was obtained in the same manner as in Example 1 except that, as shown in Table 1, the blending amount of the isocyanate-based crosslinking agent (CORONATE L™, manufactured by Nippon Polyurethane Industry Co., Ltd.) was changed to 3 parts by weight based on 100 parts by weight of the acrylic polymer (copolymer) and the thickness of each pressure-sensitive adhesive layer was changed to 20 μm.

### Example 4

A double-sided pressure-sensitive adhesive sheet was obtained in the same manner as in Example 1 except that, as shown in Table 1, the blending amount of the isocyanate-based crosslinking agent (CORONATE L™, manufactured by Nippon Polyurethane Industry Co., Ltd.) was changed to 4 parts by weight based on 100 parts by weight of the acrylic polymer (copolymer) and the thickness of each pressure-sensitive adhesive layer was changed to 40 μm.

### Comparative Example 1

A double-sided pressure-sensitive adhesive sheet was obtained in the same manner as in Example 1 except that, as shown in Table 1, a PET film (LUMIRROR S-27™, manufactured by Toray Industries, Inc.; thickness: 75 μm, wetting tension: 43 mN/m (the wetting tension is the same on both sides)) was used as the substrate.

### Comparative Example 2

A double-sided pressure-sensitive adhesive sheet was obtained in the same manner as in Example 1 except that, as shown in Table 1, a nonwoven fabric (CB-175 GENSHI™, manufactured by Japan Paperboard Industries Co., Ltd.; thickness: 45 μm, basis weight: 17 g/m²) was used as the substrate and the thickness of each pressure-sensitive adhesive layer was changed to 70 μm.

### (Evaluation)

The double-sided pressure-sensitive adhesive sheets obtained in Examples and Comparative Examples were subjected to evaluations shown in Table 1. The measuring methods or evaluation methods are as follows. Also, the gel fraction of the pressure-sensitive adhesive layer in the double-sided pressure-sensitive adhesive sheets obtained in Examples and Comparative Examples was measured by the method described above.

### (1) 180° Peeling Pressure-Sensitive Adhesive Force (to SUS Plate)

One pressure-sensitive adhesive surface of the double-sided pressure-sensitive adhesive sheets obtained in Examples and Comparative Examples (in the case of the double-sided pressure-sensitive adhesive sheet obtained in Examples, the surface of the pressure-sensitive adhesive layer on the opposite side) was lined with a PET film (LUMIRROR S10 #25™, manufactured by Toray Industries, Inc.; thickness: 25 μm), and a tape strip of 20 mm (width)×100 mm (length) was cut out therefrom and used as a measurement sample.

The measurement sample was subjected to a 180° peel test. The measurement sample and a test plate (SUS304 polishing plate) were laminated together by moving a 2-kg rubber roller (width: about 30 mm) back and forth once thereover in an atmosphere of 23° C. and 50% RH and after the passage of 30 minutes, the measurement sample was peeled off by using a tensile tester. The load at this time was measured and shown in the column “180° peeling pressure-sensitive adhesive force (to SUS plate)” of Table 1.

The measurement was performed in an atmosphere of 23° C. and 50% RH under the conditions of a peel angle of 180° and a tensile speed of 300 m/min. The measurement was performed three times, and the average value was calculated.

### (2) Releasability Evaluation Test

One pressure-sensitive adhesive surface of the double-sided pressure-sensitive adhesive sheets obtained in Examples and Comparative Examples (in the case of the double-sided pressure-sensitive adhesive sheet obtained in Examples, the surface of the pressure-sensitive adhesive layer on the opposite side) was lined with a PET film (LUMIRROR S10 #25™, manufactured by Toray Industries, Inc.; thickness: 25 μm), and a tape strip of 20 mm (width)×100 mm (length) was cut out therefrom. Subsequently, another pressure-sensitive adhesive surface (in the case of the double-sided pressure-sensitive adhesive sheet obtained in Examples, the surface of the pressure-sensitive adhesive layer on the corona-treated surface side) was laminated (pressure-contacted) to a polystyrene plate (POLYSTYRENE PLATE™, manufactured by RP TOPLA Limited, 30 mm (width)×120 mm (length), thickness: 2 mm) by moving a 2-kg roller (rubber roller, width: about 30 mm) back and forth once thereover, and the obtained laminate was used as the measurement sample.

The measurement sample was left standing for 1 month in an atmosphere of 60° C. and 90% RH and further left standing for 24 hours in an atmosphere of 23° C. and 50% RH, and then, the tape strip was peeled off from the polystyrene plate in an atmosphere of 23° C. and 50% RH by using a tensile tester under the conditions of a peel angle of 180° and a tensile speed of 10 m/min. After the separation of the tape strip, the surface of the polystyrene plate was observed with an eye, and the releasability was rated A (good releasability) when an adhesive residue was not generated, and rated B (poor releasability) when an adhesive residue was generated. The results are shown in the column “Releasability” of Table 1.

### (3) Workability (See, FIG. 4)

Each of the double-sided pressure-sensitive adhesive sheets obtained in Examples and Comparative Examples was cut into a size of 10 mm (width)×150 mm (length), and the separator was peeled off.

One pressure-sensitive adhesive surface of the double-sided pressure-sensitive adhesive sheet 21 was laminated to and fixed on the surface of a measurement table 22 having a horizontal surface such that only a longitudinal part of 50 mm from the longitudinal terminal end of the double-sided pressure-sensitive adhesive sheet 21 protrudes from the end of the measurement table 22 (that is, only a longitudinal part of 100 mm from the longitudinal terminal end of the double-sided pressure-sensitive adhesive sheet 21 was laminated to the surface of the measurement table 22).

The vertical distance (24 in FIG. 4) with respect to the horizontal plane including the measurement table surface, at the position of the terminal end part 23 of the double-sided pressure-sensitive adhesive tape extruding from the measurement table was measured with a caliper, and this was taken as a “deflection distance” of the double sided pressure-sensitive adhesive sheet. In this connection, whether the deflection distance is large or small indicates whether the elasticity of the double-sided pressure-sensitive adhesive tape is strong or weak, and this is an indicator indicating whether the workability at the lamination or separation of the double-sided pressure-sensitive adhesive tape (laminating workability and peeling workability) is good or poor. The workability was rated A when the deflection distance is 35 mm or less (good workability), and rated B when the deflection distance is more than 35 mm (poor workability). The results are shown in the column “Workability” of Table 1.

### (4) Constant-Load Peel Test (See, FIGS. 1 to 3)

One pressure-sensitive adhesive surface of the double-sided pressure-sensitive adhesive sheets obtained in Examples and Comparative Examples (in the case of the double-sided pressure-sensitive adhesive sheet obtained in Examples, the surface of the pressure-sensitive adhesive layer on the opposite side) was lined with a PET film (LUMIRROR S10 #25™, manufactured by Toray Industries, Inc.; thickness: 25 μm), and a tape strip of 20 mm (width)×60 mm (length) was cut out therefrom and used as a measurement sample 12 (a laminate of double-sided pressure-sensitive adhesive sheet/PET film).

Another pressure-sensitive adhesive surface of the measurement sample 12 (in the case of the double-sided pressure-sensitive adhesive sheet obtained in Examples, the surface of the pressure-sensitive adhesive layer on the corona-treated surface side) was pressure-contacted to one surface (in the center) of a polystyrene plate 11 (POLYSTYRENE PLATE™, manufactured by RP TOPLA Limited, 100 mm (length)×30 mm (width)) by moving a 2-kg rubber roller (width: about 30 mm) back and forth once thereover, and the laminate was cured for 30 minutes.

Subsequently, the polystyrene plate 11 was horizontally placed by using a clamp, such that the surface laminated with the measurement sample 12 is the bottom surface (see, FIGS. 1 and 2).

As shown in FIGS. 1 and 2, the measurement sample 12 was separated from the polystyrene plate 11 by peeling 5 mm longitudinally from the longitudinal terminal end of the sample. Furthermore, a weight 13 of 100 g was hung with thread from the longitudinal edge (the peeled part above) of the measurement sample 12, and a load of 100 gf (0.98 N) was applied in the direction perpendicular to the surface of the polystyrene plate 11 (in the bottom direction). Here, the weight 13 was fixed to the distal end of a thread passed through a hole created at a widthwise center in the part of 5 mm from the longitudinal terminal end of the measurement sample 12.

After applying the load as above, the system was left standing for 3 hours under the conditions of 23° C. and 50% RH, and the distance (peeling distance) 16 for which the measurement sample 12 was separated with the passage of 3 hours after the start of measurement (during standing for 3 hours), was measured. The results are shown in the column “Peeling distance” of Table 1.

In this connection, the peeling distance 16 is a peeling distance in the longitudinal direction of the measurement sample 12 and indicates a distance 16 between the terminal end position 14 at which the double-sided pressure-sensitive adhesive sheet and the polystyrene plate were closely contacted at the start of measurement, and the terminal end position 15 at which the double-sided pressure-sensitive adhesive sheet and the polystyrene plate were closely contacted after the passage of 3 hours (see, FIGS. 2 and 3). The peeling distance 16 is measured as the center distance in the widthwise direction of the measurement sample 12.

### (5) Tensile Strength (Breaking Strength) and Yield Point Strength

Each of the double-sided pressure-sensitive adhesive sheets obtained in Examples and Comparative Examples was punched out into a shape of 10 mm (width)×100 mm (length) to prepare a test specimen. Here, the sheet was punched out such that the longitudinal direction of the test specimen is the machine direction of the double-sided pressure-sensitive adhesive sheet.

A tensile test of the test specimen was performed using a tensile tester in an atmosphere of 23° C. and 50% RH by setting the chuck-to-chuck distance (initial length) to 50 mm and the tensile speed to 100 mm/min, and the breaking strength and yield point strength of the double-sided pressure-sensitive adhesive sheet were measured. The number of tests (number n) was 3, and the average value was calculated. The results are shown in Table 1.

TABLE 1

| | | | Example 1 | Example 2 | Example 3 |
|---|---|---|---|---|---|
| Acrylic polymer | Monomer composition (compositional ratio) | | BA/AA/HEA/VA | BA/AA/HEA/VA | BA/AA/HEA/VA |
| | | | 100/2/0.1/5 | 100/2/0.1/5 | 100/2/0.1/5 |
| Crosslinking agent | Amount based on 100 parts by | CORONATE L | 2 | 2 | 3 |
| | weight of acrylic polymer | | | | |
| | (parts by weight) | | | | |
| Tackifier resin | Amount based on 100 parts by | SUMILITERESIN PR- | 25 | 25 | 25 |
| | weight of acrylic polymer | 12603 | | | |
| | (parts by weight) | PENSEL D125 | 15 | 15 | 15 |
| Substrate | Kind | | PET with one corona- | PET with | PET with |
| | | | treated surface | one corona- | one corona- |
| | | | | treated surface | treated surface |
| | Thickness (μm) | | 75 | 38 | 75 |
| | Young's modulus (MD) (GPa) | | 4.1 | 4.1 | 4.1 |
| Pressure-sensitive | Thickness (μm) | | 50 | 40 | 20 |
| adhesive layer | Gel fraction (%) | | 25 | 25 | 37 |
| 180° peeling pressure-sensitive adhesive force (to SUS plate) (N/20 mm) | | | 22 | 17 | 21 |
| Tensile Strength (N/10 mm) | | | 50 | 90 | 150 |
| Yield point strength (N/10 mm) | | | 90 | 40 | 90 |
| Workability | | | A | A | A |
| Releasability | | | A | A | A |
| Peeling distance (nm) | | | 2.0 | 4.0 | 6.1 |
| | | | | Comparative | Comparative |
| | | | Example 4 | Example 1 | Example 2 |
| Acrylic polymer | Monomer composition (compositional ratio) | | BA/AA/HEA/VA | BA/AA/HEA/VA | BA/AA/HEA/VA |
| | | | 100/2/0.1/5 | 100/2/0.1/5 | 100/2/0.1/5 |
| Crosslinking agent | Amount based on 100 parts | CORONATE L | 4 | 2 | 2 |
| | by weight of acrylic polymer | | | | |
| | (parts by weight) | | | | |
| Tackifier resin | Amount based on 100 parts | SUMILITERESIN PR- | 25 | 25 | 25 |
| | by weight of acrylic polymer | 12603 | | | |
| | (parts by weight) | PENSEL D125 | 15 | 15 | 15 |
| Substrate | Kind | | PET with one corona- | PET | nonwoven fabric |
| | | | treated surface | | |
| | Thickness (μm) | | 75 | 75 | 45 |
| | Young's modulus (MD) (GPa) | | 4.1 | 4.1 | 0.35 |
| Pressure-sensitive | Thickness (μm) | | 40 | 50 | 70 |
| adhesive layer | Gel fraction (%) | | 48 | 25 | 25 |

| | | | |
|---|---|---|---|
| 180° peeling pressure-sensitive adhesive force (to SUS plate) (N/20 mm) | 20 | 22 | 14 |
| Tensile Strength (N/10 mm) | 150 | 150 | 17 |
| Yield point strength (N/10 mm) | 90 | 90 | 14 |
| Workability | A | A | B |
| Releasability | A | B | A |
| Peeling distance (nm) | 11 | 2.0 | 2.2 |

As apparent from the results in Table 1, the double-sided pressure-sensitive adhesive sheet of the present invention (Examples) exhibited good workability even when used in a narrow or long form, and excelled at the adhesive property and releasability. Furthermore, when the thickness of the pressure-sensitive adhesive layer, the blending amount of the crosslinking agent, and the gel fraction of the pressure-sensitive adhesive layer were controlled to respective appropriate ranges (Examples 1 and 2), the separation resistance against constant load was particularly excellent. On the other hand, when a PET film with surface being not subjected to a corona treatment is used as the plastic film substrate (Comparative Example 1), the anchoring property of the pressure-sensitive adhesive layer to the PET film was lacking and the releasability was poor. Also, in the case where nonwoven fabric was used as the substrate of the double-sided pressure-sensitive adhesive sheet (Comparative Example 2), the workability was poor due to no elasticity.

Abbreviations in Table 1 are as follows.
BA: n-Butyl acrylate
AA: Acrylic acid
HEA: 2-Hydroxyethyl acrylate
VA: vinyl acetate

CORONATE L:

CORONATE L™, manufactured by Nippon Polyurethane Industry Co., Ltd., isocyanate-based crosslinking agent
SUMILITERESIN PR-12603:

SUMILITERESIN PR-12603™, manufactured by Sumitomo Bakelite Co., Ltd., terpene phenolic resin
PENSEL D125:

PENSEL D125™, manufactured by Arakawa Chemical Industries, Ltd., polymerized rosin ester resin

While the present invention has been described in detail and with reference to specific embodiments thereof, it will be apparent to one skilled in the art that various changes and modifications can be made therein without departing from the scope thereof.

This application is based on Japanese patent application No. 2010-117578 filed on May 21, 2010, the entire contents thereof being hereby incorporated by reference.

Further, all references cited herein are incorporated in their entireties.

1. A double-sided pressure-sensitive adhesive sheet comprising:
a plastic film substrate; and
a pressure-sensitive adhesive layer on both sides of the plastic film substrate,
wherein a 180° peeling pressure-sensitive adhesive force of a surface (surface A) of one of the pressure-sensitive adhesive layer to a stainless steel plate as measured at a tensile speed of 300 mm/min is 8 N/20 mm or more, and an adhesive residue is not generated in the following releasability evaluation test:
releasability evaluation test:
the surface A of the double-sided pressure-sensitive adhesive sheet is laminated to a polystyrene plate such that the laminated part has a size of 20 mm in width and 100 mm in length, the laminate is left standing for 1 month in an atmosphere of 60° C. and 90% RH, the double-sided pressure-sensitive adhesive sheet is then peeled off from the polystyrene plate under the conditions of a peel angle of 180° and a tensile speed of 10 m/min, and the presence or absence of an adhesive residue on the surface of the polystyrene plate is evaluated with an eye.

2. The double-sided pressure-sensitive adhesive sheet according to claim 1, wherein a peeling distance measured by the following constant-load peel test is 10 mm or less:
constant-load peel test:
the surface A of the double-sided pressure-sensitive adhesive sheet having a size of 20 mm in width and 60 mm in length is laminated to one surface of a polystyrene plate, the laminate is pressure-contacted by moving a 2-kg rubber roller back and forth once thereover and then cured for 30 minutes, and then a load of 100 gf in a direction perpendicular to the surface of the polystyrene plate is applied to a longitudinal terminal end of the double-sided pressure-sensitive adhesive sheet under the conditions of 23° C. and 50% RH, and the peeling distance of the double-sided pressure-sensitive adhesive sheet after the passage of 3 hours is measured.

3. The double-sided pressure-sensitive adhesive sheet according to claim 1, wherein the plastic film substrate is a plastic film substrate in which out of surfaces of the plastic film substrate, at least the surface on the surface A side is a strong adhesion-treated surface.

4. A double-sided pressure-sensitive adhesive sheet comprising:
a plastic film substrate; and
a pressure-sensitive adhesive layer on both sides of the plastic film substrate,
wherein one of the pressure-sensitive adhesive layer is a pressure-sensitive adhesive layer a having a gel fraction of 5 to 50% and being formed from a pressure-sensitive adhesive composition comprising a tackifying resin and an acrylic polymer comprising, as an essential monomer component, an alkyl(meth)acrylate having a linear or branched alkyl group having a carbon number of 4 to 9, and out of surfaces of the plastic film substrate, at least the surface on the side where the layer a is included is a strong adhesion-treated surface.

5. The double-sided pressure-sensitive adhesive sheet according to claim 4, wherein a content of the acrylic polymer is from 50 to 99 wt % based on 100 wt % of a solid content of the pressure-sensitive adhesive composition.

6. The double-sided pressure-sensitive adhesive sheet according to claim 4, wherein.the acrylic polymer comprises at least one of n-butyl acrylate and 2-ethylhexyl acrylate as an essential monomer component.

7. The double-sided pressure-sensitive adhesive sheet according to claim 4, wherein the acrylic polymer comprises, as a monomer component, n-butyl acrylate in an amount of 50 wt % or more based on 100 wt % of the total amount of a monomer component constituting the acrylic polymer.

8. The double-sided pressure-sensitive adhesive sheet according to claim 4, wherein the pressure-sensitive adhesive composition comprises a tackifying resin in an amount of from 10 to 50 parts by weight and an isocyanate-based crosslinking agent in an amount of 1.0 part by weight or more and less than 3.0 parts by weight based on 100 parts by weight of the acrylic polymer, and a thickness of the layer a is from 2 to 100 μm.

9. The double-sided pressure-sensitive adhesive sheet according to claim 1, wherein a thickness of the plastic film substrate is from 20 to 200 μm.

10. The double-sided pressure-sensitive adhesive sheet according to claim 4, wherein a thickness of the plastic film substrate is from 20 to 200 μm.

11. The double-sided pressure-sensitive adhesive sheet according to claim 1, wherein a breaking strength in the machine direction is 50 N/10 mm or more and a yield point strength in the machine direction is 20 N/10 mm or more.

12. The double-sided pressure-sensitive adhesive sheet according to claim 4, wherein a breaking strength in the machine direction is 50 N/10 mm or more and a yield point strength in the machine direction is 20 N/10 mm or more.

13. A method for using the double-sided pressure-sensitive adhesive sheet according to claim 1, comprising laminating the surface A (surface of the layer a) of the double-sided pressure-sensitive adhesive sheet to a recyclable member in home electric appliances or an OA equipment.

14. A method for using the double-sided pressure-sensitive adhesive sheet according to claim 4, comprising laminating the surface A (surface of the layer a) of the double-sided pressure-sensitive adhesive sheet to a recyclable member in home electric appliances or an OA equipment.
